(19) United States
(12) Patent Application Publication
(10) Pub. No.: US 2009/0280450 A1
(43) Pub. Date: Nov. 12, 2009

(54) PRE-FORMED HARD-SHELL ATTACHMENT DEVICES FOR DENTAL APPLIANCES

(76) Inventor: Eric Kuo, Foster City, CA (US)

Correspondence Address: KLEIN, O'NEILL & SINGH, LLP, 43 CORPORATE PARK, SUITE 204, IRVINE, CA, 92606, US

(21) Appl. No.: 12/118,550

(22) Filed: May 9, 2008

(51) Int. Cl. A61C 7/16

(52) U.S. Cl. 433/9

(57) ABSTRACT

A dental appliance attachment device includes a rigid, substantially non-deformable shell having a hollow interior and an exterior surface defining an external configuration of the attachment device. A curable, adhesive filler is provided in the interior of the shell. The resin is adhesively bondable to the tooth surface upon being cured so as to semi-permanently bond both the shell and the filler to the surface of the tooth. The shell, with the uncured filler material, is placed on the tooth surface at a desired site with a placement device, which may be either a placement template or an elongate placement implement. The filled shell is detachably fixed to the placement device, so that when the filled shell is placed on the tooth surface, the placement device may be removed before the filler is cured to bond the attachment device to the tooth surface.

### CROSS-REFERENCE TO RELATED APPLICATIONS

Not Applicable

### FEDERALLY SPONSORED RESEARCH OR DEVELOPMENT

Not Applicable

### BACKGROUND OF THE INVENTION

This disclosure relates to the field of dental appliances, particularly orthodontic appliances. More specifically, it relates to attachment devices applied to the dentition of a patient for the attachment or anchoring of a dental appliance (such as an orthodontic appliance) and to methods of making such attachment devices and of installing them or affixing them to dental surfaces.

Orthodontic treatments involve repositioning misaligned teeth and improving bite configurations for improving cosmetic appearance and dental function. Repositioning teeth is accomplished by applying controlled forces to the teeth over an extended period of time. Methods have been developed to reposition a patient's teeth to a prescribed tooth arrangement (i.e. a desired final arrangement of each tooth in a patient's jaw) according to a planned course of treatment using a series of appliances in a prescribed sequence. Each of the series of incremental position adjustment appliances is sequentially placed over the patient's teeth, gradually repositioning the teeth until the prescribed tooth arrangement is achieved. Each appliance represents a pre-existing stage in a series of pre-existing stages for repositioning the teeth to a prescribed final position. This method is described in U.S. Pat. No. 5,975,893, assigned to the assignee of the present application, and the complete disclosure of which is incorporated herein by reference.

The aforementioned U.S. Pat. No. 5,975,893 also discloses the use of a sequential series of elastic polymeric positioning appliances, or aligners, suitable for carrying out the above-mentioned method. Such aligners comprise a thin shell of elastic polymer that generally conforms to all or part of a patient's dentition in either the lower dental arch or the upper dental arch, with the first aligner in the sequential series being slightly out of alignment with the initial tooth arrangement, and with each successive aligner in the series being closer to the prescribed final arrangement. Placement of an aligner over the teeth applies controlled forces to specific locations of the dentition to move the teeth gradually to the next incremental position, at which time it is removed and the next aligner in the sequential series is installed. This process is repeated until the final arrangement achieved.

When an aligner, of the type discussed above, is placed on the teeth, one or more teeth will provide a base or anchor region for holding the aligner in place while the aligner applies a repositioning force against the teeth. The anchoring and repositioning abilities of the aligner are, however, limited by such factors as the physical features and geometry of the patient's individual teeth, dental arch, and palate, and by the extent and presence of previous dental work, such as bridges, crowns, prosthetics, etc. For example, it may be difficult, in certain instances for polymeric repositioning appliances to apply certain forces to individual teeth, such as extrusive forces (e.g., pulling or lifting a tooth relative to the jaw), and rotational forces.

Various types of attachment devices have been devised that are fixed to an appropriate tooth surface so as to provide an anchor for the repositioning appliance, whereby the appliance can apply effective and appropriate repositioning forces to the teeth. Such attachment devices are disclosed, for example, in U.S. Pat. No. 6,705,863, assigned to the assignee of the present application, and the disclosure of which is incorporated herein in its entirety.

Briefly described, one type of prior art attachment device is made in situ, directly in the patient's mouth, by filling a template with a curable dental composite and positioning the template on the patient's teeth. The curable composite is then cured, leaving the cured attachment device fixed to the desired location on the surface of the tooth. The resultant attachment device is illustrated in FIG. 8, in which a cured composite attachment device 10 is shown fixed to a tooth surface 20. With this type of attachment device, the composite resin material is subject to abrasion from the repositioning appliance and from the patient's chewing actions. Consequently, the edges of the attachment device, which may include the undercuts needed to hold the appliance, may become worn down over time, and thus lose effectiveness in retaining the appliance on the teeth.

Another type of prior art attachment device is illustrated in FIG. 9. This type of attachment device is a pre-formed attachment device 10′ having an adhesive layer 30 on its bottom (fixation) surface. The device 10′ is advantageously positioned on the tooth surface 20 by a template (not shown) and then fixed or bonded to the tooth surface 20 by the adhesive layer 30. The pre-formed attachment device 10′ may be made of a more durable, wear-resistant material, such as metal, glass, or silicone-filled polymers, for example, so that they are not as prone to being worn down as the in situ-cured device 10. It has been found, however, that the preformed device 10′ may be subject to de-bonding at the adhesive layer 30 in certain instances.

It would therefore be desirable to provide an improved attachment device that is not subject either to premature wear or to de-bonding from the tooth surface.

### SUMMARY OF THE INVENTION

Broadly, the present invention is, in one aspect, a dental appliance attachment device that is adhesively attachable to a tooth surface, wherein the attachment device comprises a rigid, substantially non-deformable shell having a hollow interior and an exterior surface defining an external configuration of the attachment device; and a filler comprising a curable resin in the interior of the shell, the resin being adhesively bondable to the tooth surface upon being cured so as to attach both the shell and the filler to the surface of the tooth.

In another aspect, the present invention is a kit for forming a dental appliance attachment device on a tooth surface, wherein the kit comprises a rigid, substantially non-deformable shell having a hollow interior and an exterior surface defining an external configuration of the attachment device; a filler comprising a curable resin in the interior of the shell, the resin being adhesively bondable to the tooth surface upon being cured so as to attach both the shell and the filler to the tooth surface; and a placement device operable to position the shell on the tooth surface so as to allow the resin to bond to the tooth surface.

In still another aspect, the present invention is a method for forming a dental appliance attachment device on a tooth surface, wherein the method comprises (a) providing a rigid, substantially non-deformable shell having a hollow interior and an exterior surface defining an external configuration of the attachment device; (b) detachably fixing the exterior surface of the shell to a placement device; (c) filling the interior of the shell with a filler comprising a curable resin that is adhesively bondable to the tooth surface upon being cured so as to attach both the shell and the filler to the surface of the tooth, and placing the filled shell onto the tooth surface with the placement device so as to allow the filler to adhere to the tooth surface; (d) curing the resin of the filler to bond the filler and the shell to the tooth surface; and (e) detaching the placement device from the exterior surface of the shell, leaving the shell and the cured filler as the attachment device bonded to the tooth surface.

### BRIEF DESCRIPTION OF THE DRAWINGS

FIG. 1 is a perspective view of a patient's lower dental arch with attachment devices in accordance with the present invention fixed thereto showing the installation of a polymeric repositioning appliance (aligner) thereon;

FIG. 2A is a perspective view of a portion of a patient's dentition, showing a tooth surface that has been prepared for the fixation of an attachment device thereto;

FIG. 2B is a view similar to that of FIG. 2A, showing an attachment device in accordance with the present invention affixed to the previously-prepared tooth surface.

FIG. 3 is a perspective view of an attachment device shell in accordance with a first embodiment of the present invention;

FIG. 4 is a perspective view of an attachment device shell in accordance with a second embodiment of the present invention;

FIG. 5 is a perspective view of an attachment device shell in an installation template;

FIG. 6 is a perspective view of an attachment device shell attached to the end of an installation tool or implement;

FIG. 7A is a cross-sectional view of an attachment device in accordance with the present invention being fixed to a tooth surface by the installation template of FIG. 5;

FIG. 7B is a cross-sectional view of an attachment device in accordance with the present invention being fixed to a tooth surface by the installation tool or implement or FIG. 6;

FIG. 7C is a cross-sectional view of an attachment device in accordance with the present invention after it has been fixed to a tooth surface;

FIG. 8 is a cross-sectional view of one type of prior art attachment device fixed to a tooth surface; and

FIG. 9 is a cross-sectional view of another type of prior art attachment device fixed to a tooth surface.

### DETAILED DESCRIPTION OF THE INVENTION

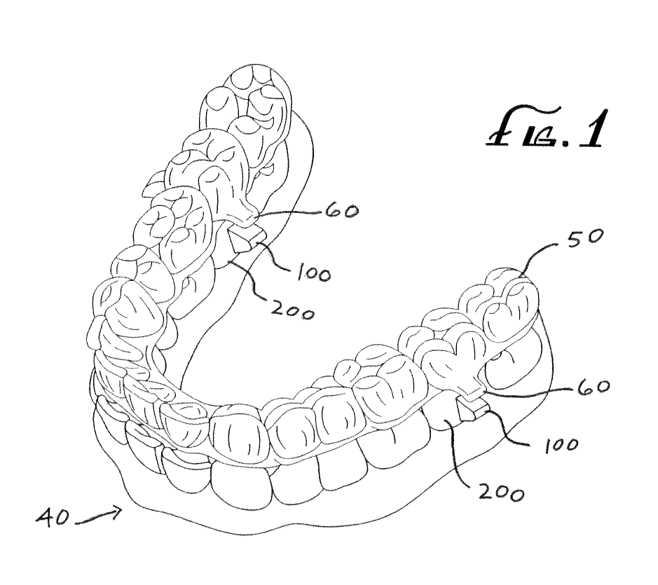

Referring first to FIG. 1, a patient's dental arch 40 (here, the lower arch) is shown with a first attachment device 100 affixed to the surface of a first tooth 200, and a second attachment device 100 affixed to the surface of a second tooth 200. The attachment devices 100 are made and installed on their respective teeth 200 in accordance with the disclosure below. The attachment devices 100 are fixed to the appropriate teeth, and at the appropriate locations on the surface of each tooth 200 to which they are affixed to provide the desired repositioning force profile for a polymeric repositioning appliance (aligner) 50 to move the patient's teeth to the next incremental position toward the desired final configuration. The appliance 50 is provided with a receptacle or socket 60 corresponding to each of the attachment devices 100, so that when the appliance 50 is installed on the dental arch 40, as shown in FIG. 1, each of the attachment devices 100 is received in a corresponding receptacle or socket 60. The interior configuration of each receptacle or socket 60 may be the same as the exterior configuration of its associated attachment device 100, or it may differ, depending on the desired force profile to be achieved.

Prior to fixing an attachment device 100 to a tooth surface, the tooth surface may advantageously be prepared for better adhesion of the attachment device 100 in accordance with the method described below. FIG. 2A shows a tooth 200 with an attachment adhesion site 102 on its surface at the location where an attachment device 100 is to be affixed. The attachment adhesion site 102 may be prepared by cleaning the tooth surface or by chemical etching the tooth surface with a suitable dental etchant as is well-known in the practice of dentistry. Chemical etching has the advantage of leaving a textured surface that provides improved adhesion for the resin employed in the attachment device 100, as will be described below. FIG. 2B shows an attachment device 100 adhesively fixed to the tooth surface at the adhesion site 102.

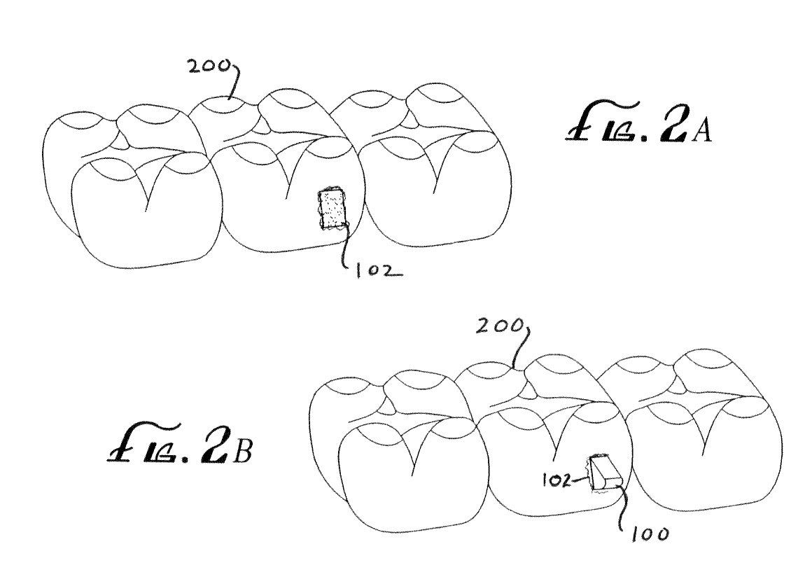

Referring to FIGS. 3-6, the attachment device 100 comprises a rigid and thin, but substantially non-deformable, open-faced shell 104 having an exterior surface defining an external configuration of the attachment device 100, and a hollow interior filled with a curable adhesive filler 106. The shell 104 is made of a hard, durable polymer (plastic), porcelain, or any other durable material that is substantially immune to abrasion and deformation due to chewing actions. Ideally, the shell 104 has wear properties similar to those of tooth enamel to prevent adjacent or opposing tooth surfaces from being worn down by contact with the attachment device 100. A material with this characteristic is crystalline hydroxyapatite. As will be discussed below, the shell material may be transparent or translucent, as well as resistant to color change.

FIG. 3 shows a shell 104, in accordance with a first embodiment, having an exterior surface 108 that is textured (as by chemical etching, sandblasting, or micromachining) for improved adhesion to a placement device, as will be discussed below. FIG. 4 shows another embodiment, in which the shell 104 has a smooth or untextured exterior surface 108′. To assure that the filler 106 adheres well to the interior of the shell 104 and thus resists separation therefrom, the shell 104 may advantageously have an interior surface that has been treated to have a surface texture. The shell 104 shown in FIG. 3 has an interior surface 110 with a mesh pattern formed by micromachining, while the shell 104 of FIG. 4 has an interior surface 110′ with a roughened, irregular texture created by means such as sandblasting or chemical etching. It should be understood that the shell 104 may have the textured exterior surface 108 of FIG. 3 and the roughened irregular interior surface 110′ of FIG. 4, or it may have the smooth exterior surface 108′ of FIG. 4 and the interior surface 110 with the micromachined mesh pattern of FIG. 3.

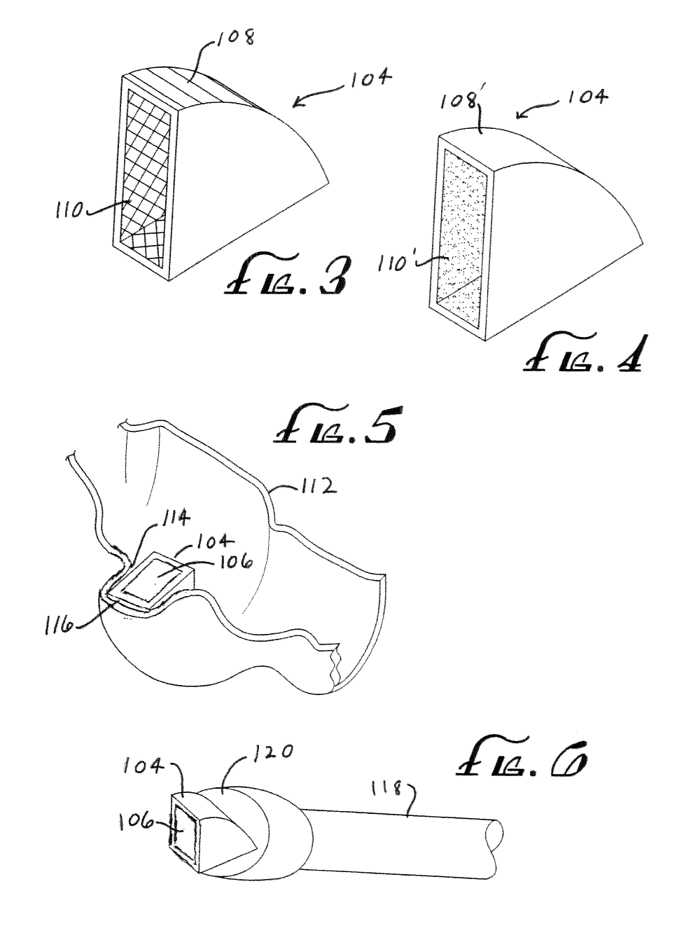

The shell 104 is next detachably fixed to a placement device and then filled with the filler 106. As shown in FIG. 5, the placement device may be a placement template 112 having an interior configuration conforming to the exterior of the tooth on which the attachment device 100 is to be installed, and possibly one or more adjacent teeth, with a portion 114 of the interior surface conforming to the exterior surface of the shell 104. The shell 104 is detachably fixed or installed in the template 112 by a temporary adhesive, such as a thin layer 116 of wax. Alternatively, as shown in FIG. 6, the placement device may be an elongate placement element or placement stick 118 with a drop or globule 120 of a temporary adhesive, such as wax, at its distal end, to which the shell 104 is detachably fixed. Adhesion between the shell 104 and either the template 112 or the stick 118 may be enhanced, if desired, if the shell 104 is provided with a textured exterior surface 108, as shown in FIG. 3.

Once the shell 104 is affixed to a placement device such as the template 112 or the stick 118, its hollow interior is filled with the curable adhesive filler 106 (see FIGS. 5 and 6). The filler 106 advantageously comprises an adhesive dental composite resin or “luting” resin, of a type well-known in the art. The resin may be, for example, a self-curing resin, a light-curable resin, or a dual-cure resin, such as flowable bisphenol A glycidylether methacrylate (“Bis-GMA”) dental composite commonly employed in dental restorations. If the resin is light-curable, the shell 104 must be transparent or at least translucent, otherwise it may opaque and of any color desired for aesthetic reasons. While shell 104 is preferably filled with the filler 106 after the shell 104 is detachably affixed to the placement device, in some instances it may be advantageous to fill the shell 104 with the filler 106 before the shell 104 is fixed to the placement device. As mentioned above, the textured interior surface 110 (FIG. 3) or 110′ (FIG. 4) provides an improved bonding surface that enhances the adhesion of the filler 106 to the shell 104, thereby reducing the probability of separation of the shell 104 from the cured filler 106.

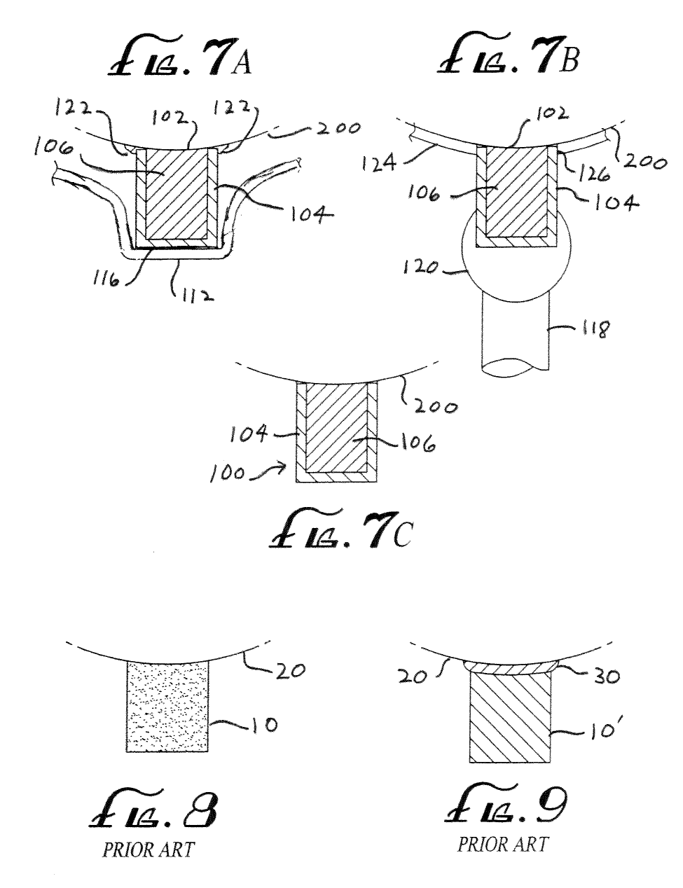

FIGS. 7A and 7B show two methods of installing the attachment device 100 on the prepared adhesion site 102 on a tooth 200. FIG. 7A shows the attachment device 100 being installed by the placement template 112. The template 112, with the attachment device 100 (comprising the shell 104 and the uncured filler 106) installed in it (as described above), is placed over the desired tooth 200, so that the filler 106 adheres to the prepared adhesion site 102. The edge of the shell 104 is pressed firmly against the tooth surface creating a tight junction therebetween. Excess filler 106 may squeeze out of the interior of the shell 104 during installation to create a filler residue or “flash” 122 around the juncture between the shell edge and the tooth surface. The flash 122 may be easily removed, without disturbing the bond between the attachment device and the tooth, owing to the tight juncture between the shell edge and the tooth. The filler 106 is then cured by the method appropriate to the particular filler material used, thereby bonding the filler 106 to the tooth surface so as to fix the attachment device 100 securely and semi-permanently to the tooth. If the filler 106 is light-curable, the placement template 112 must be transparent or at least highly translucent. If the filler 106 is chemically-cured, then the placement template 112 does not need to enable the transmission of a curing light. After the filler 106 is cured, the placement template 112 is removed by applying sufficient force to it to break the weak adhesion provided by the temporary adhesive layer 116, leaving the finished and fully installed attachment device 100, as shown in FIG. 7C.

FIG. 7B shows the installation of the attachment device 100 using the placement implement or stick 118. In this method, the attachment device 100, detachably fixed to the distal end of the stick 118, as described above, is placed on the prepared adhesion site 102 so as to allow the filler 106 to adhere to the adhesion site 102. As with the above-described installation with the placement template 112, the edge of the shell 104 is pressed firmly against the tooth surface. Any flash (not shown in FIG. 7B) may then be removed. When the filler 106 is cured, the stick 118 is detached from the shell 104, leaving the attachment device 100 securely and semi-permanently bonded to the tooth, as shown in FIG. 7C.

While placement of the attachment device using the stick 118 may be performed “freehand,” so to speak, it may be advantageous to employ a guide element, such as a bracket positioning template 124, a portion of which is shown in FIG. 7B. The positioning template 124 may be as described, for example, in U.S. Pat. No. 7,056,115, assigned to the assignee of the present application, and the disclosure of which is incorporated is incorporated herein in its entirety. The bracket positioning template 124 fits over some or all of the teeth in a dental arch, including an teeth on which an attachment device 100 is to be installed. The bracket positioning template 124 has one or more openings 126 (one of which is shown in FIG. 7B), each of which registers with an adhesion site 102, so that each adhesion site 102 is exposed and accessible through the bracket positioning template 124. Thus, each opening 126 (which may be a slot or a window) provides a guide for the proper placement of an attachment device 100 thereby facilitating the accurate placement using the placement stick 118. The bracket positioning template 124 may then be removed at an appropriate time, preferably after the filler 106 has been cured.

From the foregoing, it will be appreciated that the shell 104, the filler material 106, and the placement device (either the placement template 112 or the placement stick 118) may constitute a kit for the formation of a dental appliance attachment device on a tooth surface. Optionally, if the placement device in the kit is the above-described placement stick 118, a bracket position template would be included in the kit. Of course, a kit may comprise the components and materials needed to form the number of attachment devices needed for a particular dental appliance.

While the above disclosure describes what are currently considered as preferred embodiments, it is to be understood that the invention is not limited to the above-described exemplary embodiments. A number of modifications and variations of the several aspects of the invention will suggest themselves to those skilled in the pertinent arts, and the scope of the invention is intended to encompass such modifications, variations, and equivalent arrangements, as defined and encompassed by the appended claims.

What is claimed is:

1. A dental appliance attachment device that is adhesively attachable to a tooth surface, the attachment device comprising:
a rigid substantially non-deformable shell having a hollow interior aid an exterior surface defining an external configuration of the attachment device; and
a filler comprising a curable resin in the interior of the shell, the resin being adhesively bondable to the tooth surface upon being cured so as to attach both the shell and the filler to the surface of the tooth.

2. The dental appliance attachment device of claim 1, wherein the shell has a hardness approximately the same as that of tooth enamel.

3. The dental appliance attachment device of claim 2, wherein the shell is made of a material selected from the group consisting of a hard polymeric plastic, crystalline hydroxyapatite, and porcelain.

4. The dental appliance attachment device of claim 1 wherein the exterior surface of the shell is textured.

5. The dental appliance attachment device of claim 1, wherein the exterior surface of the shell is smooth.

6. The dental appliance attachment device of claim 1, wherein the hollow interior of the shell has an interior surface that is textured so as to enhance adhesion of the filler thereto.

7. The dental appliance attachment device of claim 1, wherein the shell is at least translucent, and wherein the resin is a light-curable resin.

8. The dental appliance attachment of claim 1, wherein the resin is a dual cure composite resin.

9. The dental appliance attachment device of claim 8, wherein the resin is a flowable Bis-GMA-based dental composite material.

10. The dental appliance attachment device of claim 1, wherein the shell has a peripheral edge that contacts the tooth surface when the shell is attached to the tooth surface by the cured resin.

11. The dental appliance attachment device of claim 1, wherein the dental appliance is a polymeric repositioning appliance.

12. The dental appliance attachment device of claim 11, wherein the appliance has an attachment device receptacle with a defined internal configuration, and wherein the external configuration of the attachment device substantially conforms to the defined internal configuration.

13. The dental appliance attachment device of claim 11, wherein the appliance has an attachment device receptacle with a defined internal configuration, and wherein the external configuration of the attachment device is different from the defined internal configuration.

14. A kit for forming a dental appliance attachment device on a tooth surface, the kit comprising:
a rigid, substantially non-deformable shell having a hollow interior and an exterior surface defining an external configuration of the attachment;
a filler comprising a curable resin in the interior of the shell, the resin being adhesively bondable to the tooth surface upon being cured so as to attach both the shell and the filler to the tooth surface; and
a placement device operable to place the shell on the tooth surface so as to allow the resin to bond to the tooth surface.

15. The kit of claim 14, wherein the placement device includes an adhesive that provides a detachable adhesion between the placement device and the exterior surface of the shell, wherein the adhesion between the placement device and the shell is breakable upon the attachment of the shell and the filler to the tooth surface.

16. The kit of claim 14, wherein the placement device comprises a template having an interior surface conforming to the exterior surface of the shell.

17. The kit of claim 145 wherein the placement device comprises an elongate element having a distal end with an adhesive applied thereto that detachably adheres to the exterior surface of the shell.

18. The kit of claim 14, wherein the shell has a hardness approximately the same as that of tooth enamel.

19. The kit of claim 18, wherein the shell is made of a material selected from the group consisting of a hard polymeric plastic, crystalline hydroxyapatite, and porcelain.

20. The kit of claim 14, wherein the shell has an interior surface that is textured so as to enhance adhesion of the filler thereto.

21. The kit of claim 14, wherein the shell is at least translucent, and wherein the resin is a light-curable resin.

22. The kit of claim 14, wherein the resin is a dual cure composite resin.

23. The kit of claim 22, wherein the resin is a flowable Bis-GMA-based dental composite material.

24. The kit of claim 14, wherein the shell has a peripheral edge that contacts the tooth surface when the shell is attached to the tooth surface by the cured resin.

25. The kit of claim 17, further comprising a guide element configured to fit on the tooth surface so as to provide a guide for the placement of the shell on the tooth surface by the elongate element.

26. The kit of claim 25, wherein the guide element has an opening that, when the guide element is disposed on the tooth surface, provides access to a site on the tooth surface at which the attachment device is to be placed by the elongate element.

27. A method for forming a dental appliance attachment device on a tooth surface, comprising:
(a) providing a rigid, substantially non-deformable shell having a hollow interior and an exterior surface defining an external configuration of the attachment;
(b) detachably fixing the exterior surface of the shell to a placement device and filling the interior of the shell with a filler comprising a curable resin that is adhesively bondable to the tooth surface upon being cured so as to attach both the shell and the filler to the surface of the tooth;
(c) placing the filled shell onto the tooth surface with the placement device so as to allow the filler to adhere to the tooth surface;
(d) curing the resin of the filler to bond the filler and the shell to the tooth surface; and
(e) detaching the placement device from the exterior surface of the shell, leaving the shell and the cured filler as the attachment device bonded to the tooth surface.

28. The method of claim 27, wherein the tooth surface is prepared before the placing of the filled shell onto the tooth surface.

29. The method of claim 28, wherein the tooth surface is prepared by at least one of cleaning and etching.

30. The method of claim 27, wherein the placement device comprises a template having an interior surface conforming to the exterior surface of the shell, and wherein the detachable fixing of the exterior surface of the shell to a placement device comprises fixing the shell into the template with an adhesive that detachably adheres to the exterior surface of the shell.

31. The method of claim 27, wherein the placement device comprises an elongate element having a distal end, and wherein the detachable fixing of the exterior surface of the shell to a placement device comprises attaching the shell to the distal end of the elongate element with an adhesive that detachably adheres to the exterior surface of the shell.

32. The method of claim 27, wherein the providing of the shell includes creating a textured interior surface of the shell so as to enhance adhesion of the filler thereto.

33. The method of claim 27, wherein the providing of the shell includes creating a textured exterior surface of the shell.

34. The method of claim 27, wherein the providing of the shell includes creating a smooth exterior surface of the shell.

35. The method of claim 27, wherein the placing of the filled shell onto the tooth surface includes positioning the filled shell so that a peripheral edge of the shell contacts the tooth surface when the filled shell is placed onto the tooth surface.

36. The method of claim 27, wherein the shell is detachably fixed to the placement device before the shell is filled with the filler.

37. The method of claim 27, wherein the shell is filled with the filler before the shell is detachably fixed to the placement device.

38. The method of claim 31, wherein the step of placing the filled shell includes the steps of:
(c)(1) providing a guide element configured to be installed on the tooth surface so as to provide access to a defined site on the tooth surface by the elongate element;
(c)(2) fitting the guide element on the tooth surface; and
(c)(3) placing the filled shell onto the tooth surface at the defined site with the placement device so as to allow the filler to adhere to the tooth surface at the defined site.

39. The method of claim 38, wherein the guide element has an opening that, when the guide element is disposed on the tooth surface, provides access to the defined site on the tooth surface by the elongate element.
